(19) United States
(12) Patent Application Publication
(10) Pub. No.: US 2014/0108180 A1
(43) Pub. Date: Apr. 17, 2014

(54) VIRTUAL ENTERTAINMENT AUCTION ROOM

(71) Applicant: PARI ESFANDIARI, Las Vegas, NV (US)

(72) Inventor: PARI ESFANDIARI, Las Vegas, NV (US)

(21) Appl. No.: 14/054,781

(22) Filed: Oct. 15, 2013

Related U.S. Application Data
(63) Continuation of application No. 61/713,869, filed on Oct. 15, 2012.

(51) Int. Cl. G06Q 30/08; G06Q 30/06

(52) U.S. Cl. CPC G06Q 30/08; G06Q 30/0643
USPC 705/26.3

(57) ABSTRACT

A method and/or process and/or configuration and/or apparatus and/or system that produce a Virtual Entertainment Auction Room (VEAR) and its components. VEAR is conditional and fee based offer with a plurality of individual auctions. One aspect of VEAR is a configuration that enable communication and collaborate with third party reward programs and/or inventory management systems. VEAR is configured to launch through web enabled free standing and/or hand held and/or counter top or bar top gaming machines, computers and/or mobile devices. It could be produced as open or server based or networked system.

### REFERENCE

This application claims the benefit of U.S. Provisional application No. 61/713,869, filed Oct. 15, 2012, which is incorporated by reference in its entirety.

### BACKGROUND

Over last decade, experiences have emerged as the next step in economic value. The empowered consumer demands enjoyable experience and the crowded market place dictate it. Businesses are faced with how to rap memorable and engaging experiences around their traditional offerings?

Online auction is a well understood business model, where products and services are auctioned for participants to bid. Bidding is free and the higher price offered within given time is the winner. Entertainment auctions also know as penny auctions are a new concept aimed at adding a sense of entertainment and engagement to the auction experience. Here, bids are not free and are bought in bundles. Participants do not name their price, each time they compete (bid) the price increases by one penny. A timer runs in reverse. Once timer hits zero the auction is over. Winner is the last person to bid.

But there is a critical flaw in the traditional entertainment auction business model (see Consumer and Producer Behavior in the Market for Penny Auctions: A Theoretical and Empirical Analysis by Ned Augenblick—January 2011, page 33). If only few people participate the business could face serious loss as its products could be sold for few pennies. Ironically, if large numbers of people participate, then players could face serious loss as the price of bids adds up. Seat auction has been developed in response to this problem. For auction to launch a minimum number of players must buy a seat in advance. But experience shows that the stand alone seat auctions are not popular because their booking requirements in hand with more predictable behavior from players diminish the thrill element regarded as the key attraction to the entertainment auction concept.

Many service and hospitality industries are inevitably face uncertain demands. This results in regular unused services/products. Yet, most of these products/services are perishable and can't be carried in inventory and sold in future date. This means huge loss of value in the form of unoccupied rooms, recreational facility and spa treatments, restaurant meals, shows, airplane seats.

Gaming machines make for a significant part of casino income. Since space is limited in a casino, a rigorous evaluation takes place to ensure popularity and profitability of gaming machines. Yet, new gaming machines with new concepts must be introduced regularly to ensure the floor is entertaining and attractive to players. Casino faces continuous demand for profitable games and gaming machines.

Loyalty/reward programs are created to encourage customer return and loyalty as well as customer increased spending. They facilitate data collection on customer behavior and spending. The programs then provide ability to segment customers and offer them loyalty/reward points accordingly. Points could be redeemed for business owned or third party products and services. Yet, every year $16 billion out of $48 billion worth of reward points issued by American businesses is not redeemed (2011 Forecast of U.S. Consumer Loyalty Program Points Value). This figure does not include large number of points that are passed to friends, family members and associates. Un-redeemed points, not only indicates that the program in its current shape is not attractive, but also present a contingent financial liability.

### JUSTIFICATION

Considering the above points, it would be advantageous to provide a method, system, application, platform, configuration and apparatus that offer Virtual Entertainment Auction Room. VEAR will overcome the current business flaw in entertainment auctions. By offering a number of auctions with different auction models, it keeps the game unpredictable with potential for multi win, keeping the auction exciting and interesting.

Additional configurations enable the application to collaborate with third party business reward/loyalty programs as well inventory management system. This not only removes business concern about the contingent financial liability caused by unredeemed reward points but also adds entertainment and excitement to reward programs. Further, it assists business to liquidate their unwanted inventory. The application could be launched through any web enabled device including, remote desk/lap top computers, tablets, cell phones, as well as bar tops and stand alone gaming machines. It could be offered through open, server based, or closed network. These capabilities enable businesses to bridge their on/off line auctions and even launch tournament style events involving a networked standalone gaming machines or other devices to create buzz in live events. In addition, installing a plasma LCD screen at a prime location showing products, latest happenings in the auction, and the person leading the auction, as well as latest winners and prizes could add extra excitement and attract larger number of players. Such a platform will benefit wide range of industries currently challenged with staging memorable and entertaining experiences for their traditional offerings. Casino industry is in a special position to benefit. Its stock of un-redeemed reward points is high, regularly faces excess perishable inventory, need to add excitement and innovative games at casino floor and its customer base are mainly gamers.

### SUMMARY OF INVENTION

One aspect of the present invention offers a method and/or system and/or configuration, and/or apparatus to launch a Virtual Entertainment Auction Room (VEAR). VEAR comprising of a plurality of entertainment auctions all starting as soon as VEAR opens at a pre-specified time but each ending as shown by their timer. For application to start pre-specified number of seats must be bought in advance by participants. Once VEAR opens, a configuration transmits each logged in participants account with a pre-specified plurality of bids to compete in their auctions of choice. These bids will expire once VEAR is closed. In each auction, the last to compete when timer hit zero is the winner of that auction. Once timer hits 30 seconds expansion kicks in. Each compete reset the timer back to thirty seconds. Auction room closes when last auction is ended.

Application offers a wide range of entertainment auction models including conditional and non-conditional, fee and non-fee based, open, exclusive to a certain group, or invite only. One aspect of this invention is a configuration and or a method for an Extended Time Auction. The game principles are the same but timer continue expands by thirty seconds until the minimum price is met.

Another aspect of the invention is a configuration that enables each individual auction to display several products from a category. The auction winner could choose her desired product from the offered products in that category.

According to another aspect of this invention, winners could Trade

In their won product for bids.

According to another aspect of this invention losers will receive credit for percentage of their used bids to buy the same product at Buy it Now price within a window of time.

According to another aspect of this invention, a Buy it Now option is offered that facilitates ability for player to bypass the penny auction game and purchase the product at fix offered price. This option could be offered before, during or after auction is started.

Another aspect of the present invention is a method and/or system and/or configuration that enable redeeming points associated with partner third party loyalty/reward points.

Another aspect of the invention is a configuration that enables each individual player to customize their experience in regard to viewing ads and/or selecting avatar.

Another aspect of this invention is a configuration that provide for a random surprise payment at the point of purchasing bids.

Another aspect of the present invention is a configuration and/or method that enable VEAR to communicate and/or collaborate with third party inventory management system.

Another aspect of the present invention offers a method and/or system and/or configuration and/or apparatus for launching VEAR through stand free gaming machines, gaming kiosks, counter top or bar top gaming machines, hand-held machines, in-room systems as well as computers and mobile devices.

Another aspect of the present invention offers a method and/or system and/or configuration for operating VEAR tournaments through online open, or server based, or closed network of gaming devices including stand free gaming machines, gaming kiosks, counter top or bar top gaming machines, hand-held machines, in-room systems as well as computers and mobile devices.

### BRIEF DESCRIPTION OF THE DRAWINGS

FIG. 1—is a diagram of the Virtual Entertainment Auction Room WEAR) application.

FIG. 2—is a screen shot of the VEAR.

FIG. 3—is a screen shot of an individual auctions page with detailed auction information.

FIG. 4—is a diagram of the auction function in relation to timer.

FIG. 5—is a diagram of a player experience.

FIG. 6—is a perspective view of a free standing gaming machine embodying the present invention.

FIG. 7—is a diagram of the control system for the gaming machine shown in FIG. 6.

### DETAILED DESCRIPTION OF THE DRAWINGS

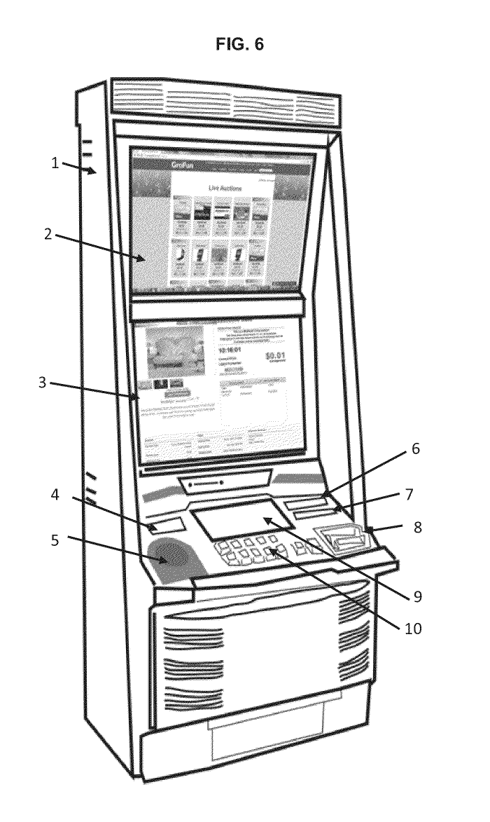

It is critical to note that the present invention could take many different forms. Therefore, illustrations and descriptions presented here only serves as examples of the key principles and should be considered as such and should not be used as a mean to limit the broad scope of the invention. For example, the gaming machine (FIG. 6) may take different operating structures, be a free standing machine, a potable or handheld device, a mobile device, a counter top or bar top gaming machine, or other personal electronic devices. Similarly, VEAR could be offered through open web, server based, or closed network systems.

Further, numerous configurations are possible including customizing the machine to favor certain segment of players. Additional customization could be provided at manufacturing level. This would be possible if player segmentation is done prior to manufacturing of gaming machines. Players are also enabled to customize their experience. For example player could turn on/off ad view or select an avatar to attach to her/his user name.

In addition, VEAR consist of several individual entertainment auctions. These auctions could have different auction models. For example, the individual auction could be a Reverse Auction where the game principles stay the same but auctions are started from a high price. Each bid reduces the product price. Fixed Price Auction will start the auction with a fixed price and bids do not affect the auction price. Similarly, entertainment auctions may impose conditions. For example Minimum Price Auction demands that the auction reach the specified amount before the auction ends. If the price is not met, there will be no winner and all bids will be refunded back. Extended Time Auction is a new auction model offered. Here, time will be increased with less than 30 seconds until the auction price reaches the minimum requested amount. Other auction models are exclusive auctions allowing certain group of players to participate, examples of this model includes Beginners Auction (first time players) or Star Auctions (won several times). Auctions could be exclusive to certain reward program, players segment, promotions, or invite-only. Additional models are Free Auctions, where bids are offered complimentary or Bonus Auctions where only bonus bids are allowed.

In addition, configuration to redeem reward points could take various forms. It could be configured in house or at the reward partner's server. Similarly, configuration could provide for auctioned items to be selected and launched in house or at vendors' server. Further, configuration enables communications and/or collaboration with vendor's inventory management system.

Please note following words are used interchangeably in the text, screen shot and diagrams:
Bid: FunNote
Bonus: BonusNote
Player: Funtender
Buy it Now: BIN
Winner: FunChamp
Bid: Compete
Butler: FunButler

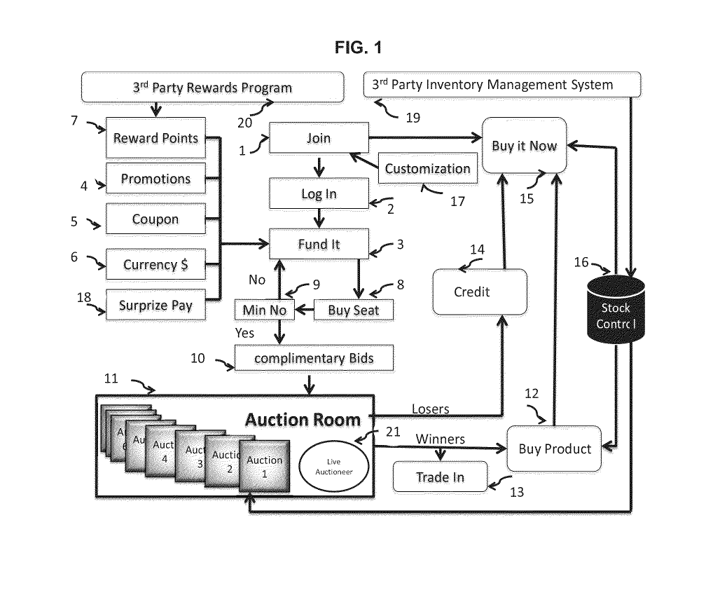

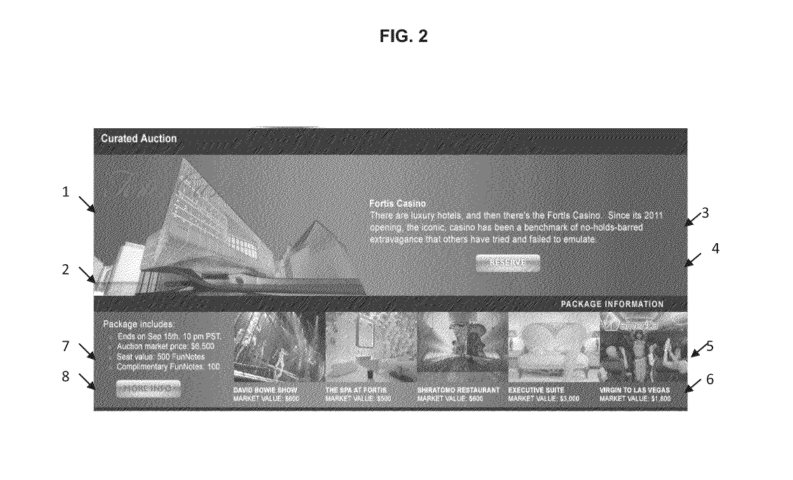

FIG. 1—This is a diagram of the VEAR application, a screen shot of which is shown at FIG. 2. To participate, players must Join and establish an account (1). At this point users have opportunity to customize their experience (17) by making choices such as selecting an avatar and/or opting in or out for ad view among other options. Once users Login (2) they need sufficient amount of bids (FunNote) to participate. Bids are obtained at Fund It (3). Bids could be obtain using one of the four methods offered, promotions (4), coupons (5), and currency including cash and credit card (6), or partner third party reward points (7). There is also a surprise random pay (18) at work to entice users. Next step to participate in a VEAR is to buy a seat (8). Seats are funded by bids.

VEAR is a conditional offer and requires a minimum number (9) of seats to be sold within the reservation period for auction to open. At the end of reservation period, if the required numbers of seats is not met, auctions will be cancelled and bids will be refunded. If the required number of seats is met then participants will be informed and auction will start as scheduled. Once VEAR (11) is open, each participant who logs in and enter VEAR will receive a fixed amount of complimentary bids (10). These bids will expire once VEAR is closed which happen as soon as the last auction in the VEAR is ended. VEAR consists of number of individual auctions, all starting at the same time as soon as VEAR opens but they end at various times as shown by the timer for that auction which displays the time left to end that auction. There is also a live auctioneer present at VEAR (21) to encourage participation and to add excitement.

It is a game of skill and players must choose carefully the auctions they want to participate and have a strategy to win including when to enter certain auction, when to bid, when to stop. There are limits for number of times a player could win an auction in the VEAR. Winners will pay for their product by currency (12). Additional option for winners is to Trade In their product for bids (13) at Buy it Now price. Losers will receive credit (14). The credit is only valid for purchase of the same item at Buy it Now price (15) and only within a specified window of time after which credits will expire. In addition, after an auction starts, players could bypass the auction and simply buy the product at Buy it Now price (15) if the option is available. A critical method and configuration enables VEAR to communicate with third party inventory management system (19) and rewards program (20).

FIG. 2—This is a screen shot of a Virtual Entertainment Auction Room NEAR). VEAR could have various designs. Here, the top box (1) displays promotional material, including an image (2) and text (3). The number of required seats and number of seats already reserved and time left to reserve will show in right side with a clear RESERVE button (4) to encourage visitors to participate by booking a seat. Individual auctions are shown at the bottom right. For each auction, there is an image (5) and brief information (6). General information about VEAR is placed at bottom left box (7). These include, market price, seat price, number of complimentary bids offered, and date VEAR starts, as well as option to read detailed information about VEAR and its individual auctions (8).

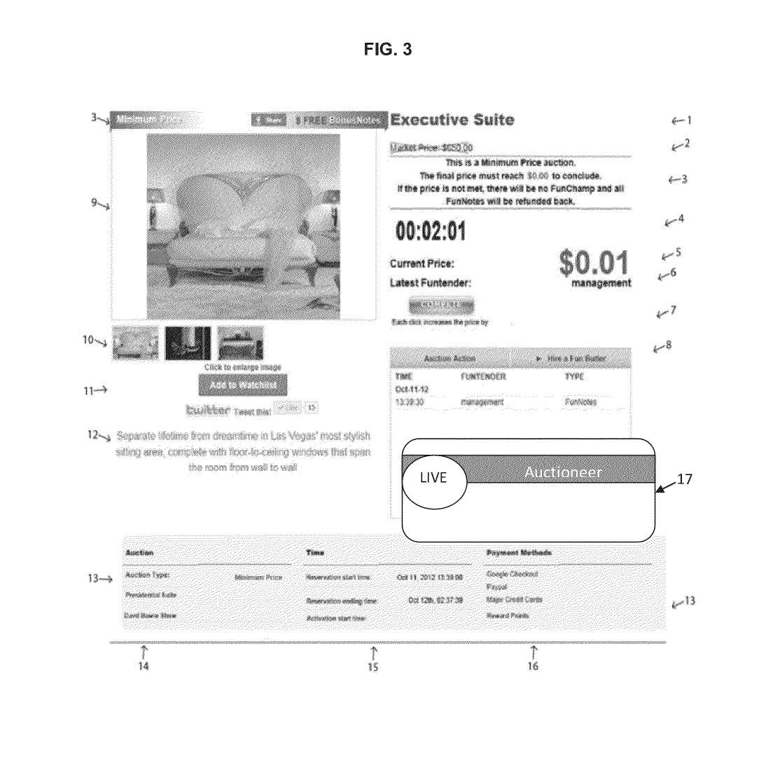

FIG. 3—It is a screen shot of an individual auction. Again design could vary and this image is aimed at clarifying the idea not to limit the design and should be treated as such.

Auction title is shown at the top (1), with market price under it (2). Buy it Now prices will be displayed here once option becomes available. Market price is followed by a description of the auction type (3) which is also shown at the top of the product image (9) in the left side. Timer (4) runs in reverse showing (00:02:01), this is remaining time before auction ends. Next is the current auction price (5) of $0.01, this is followed with the name of person leading the auction, in this image Management. Compete button (7) is placed here to enable players to participate in the auction. A box (8) shows up to five last Funtenders. It also provide for using a Fun Butler (18). Fun Butler is a configuration that allows for placing bids automatically. There is a live auctioneer (17) function that enable communication. A large picture of product (9) and pictures of alternative products (10) for the same auction are displayed at the left side. Social media (11) options are offered here. Next is information about the product (12). Lower part of the image is a three column box (13) providing detailed information about the auction. These include information about auction type and price (14), auction time (15) and payment methods (16).

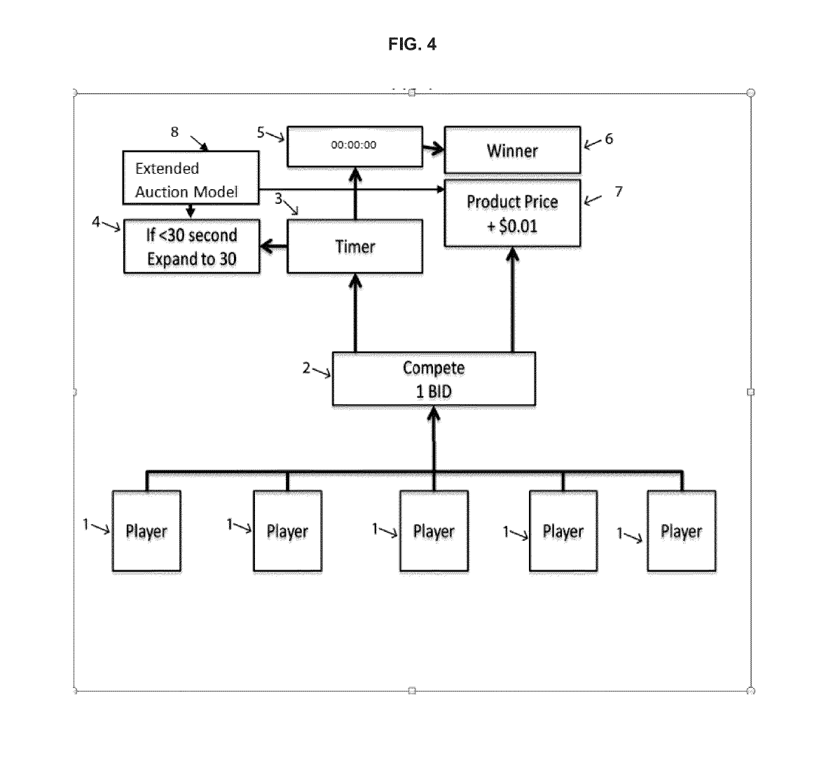

FIG. 4—This diagram elaborates on the competing and winning process in relation to the timer within an individual auction. As illustrated, players (1) participate by using Compete button (2). This increase the auction price (7) by one penny. Timer (3) works in reverse, showing the remaining time before auction ends. There is an expansion function (4) that kicks in once the timer reach 30 second. From there on each time players compete/bid the timer is extended with less than 30 seconds. For Extended auction model (8) timer will continue to extend until price reaches a minimum required amount. Once timer reach 0.00 (5) the player who leads the auction will be the winner (6). She/or he could obtain the offered product at the auction price (7) or use other options available.

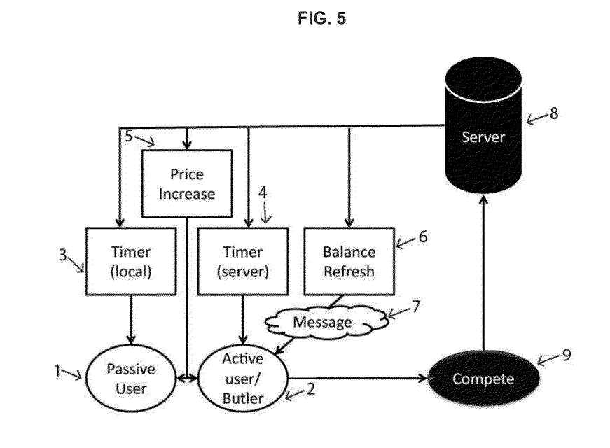

FIG. 5—This diagram elaborates on players' experience. To increase efficiency the system provides different experiences to passive (1) and active (2) users. For passive users (1), timer is decreased locally (3) and their account balance is not refreshed. On the other hand, for active (2) users timer will decrease centrally (4). Active (2) users' accounts are checked every five minutes and the account balance displayed on the screen is refreshed (6). If the balance is lower than 25 or 15, or 10 a pop up messages (7) will show to remind them to add to their bank. Product price (5) experience is the same for both passive (1) and active (2) users. As soon as a player presses Compete (9) it is communicated to the server (8). Server then will change the price shown on the screen for both passive (1) and active (2) users.

FIG. 6—This drawing shows a standalone gaming machine enabled to provide VEAR. The gaming machine compromises of a housing (1) and includes output and input devices. The various components of the gaming machine may be connected directly to or contained within the housing or may be remote and connected via wired and wireless connection methods. For output, the gaming machine includes a Primary (3) and Secondary Display (2). Displays may take the form of a high resolution LCD or a plasma display or other compatible forms. At primary screen, player will see the details of an individual auction he/she is active at that moment while secondary screen displays all live auctions within the VEAR.

Player interface enables players to launch their desired functions. It compromise of a panel with a plurality of push buttons (10) and a touch screen (9) providing identical and/or complimentary functions. Touch screen contains soft touch keys activated by underlying graphics and could be separated or mounted over the primary (3) or secondary (2) screens.

The value input device may be provided in many forms, usually located at the front of the housing. It includes a bank note reader (4) and coin acceptor (5). There is also credit card/ticket/coupon reader (6). A barcode scanner (7) enables reading of the information stored on a player card. It further authorizes access to a central account that enable redeeming points from the players' reward account. A credit printer (8) is provided to enable those who want to print their balance.

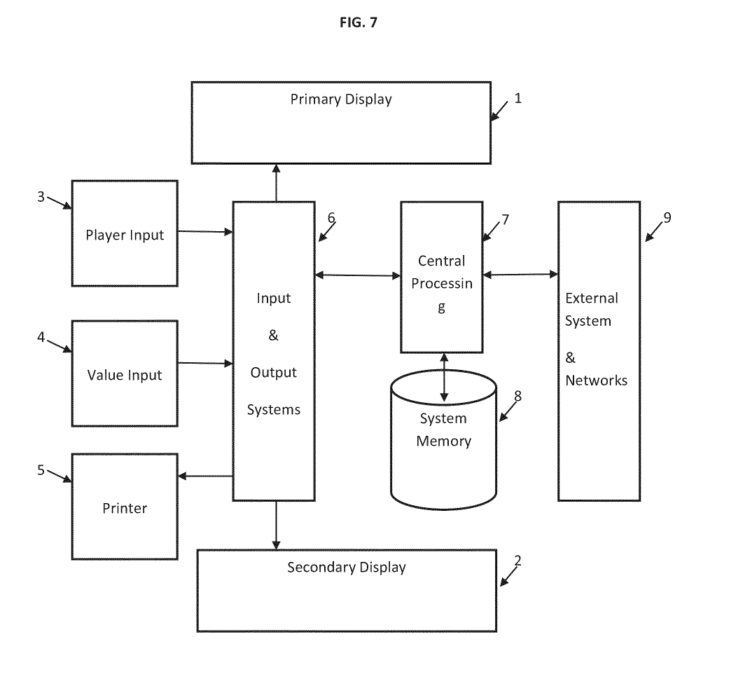

FIG. 7—It is a diagram showing the central processing unit (CPU) also known as controller (7) and its relation to various components of the gaming machine (FIG. 6). The controller may or may not reside in the gaming machine's housing. It functions as a communicator between gaming machine and external system. The communication takes place through input/output circuits (6) and a communication path (6). Controller receives player inputs (3), value inputs (4) and value outputs (5). For value input it is assisted by a money/credit detector and for value output it uses a payoff mechanism.

Controller executes game programs stored in the system memory (8). The system memory may include a non/volatile memory, RAM and multiple program memories. It executes games code, monitors the players play and determines game outcomes while the controller on board of the gaming machine processes display information to be displayed on the primary (1) and secondary (2) displays of the gaming machine.

Finally, controller communicates with the external systems through the input/output circuits and a communication path. The external system (9) may include a gaming network, other gaming machines, communication hardware, a server, or/and a verity of other interfaced systems or components.

I claim:

1. A method for producing a virtual entertainment auction room comprising:
a computer program to host the entertainment auction room, the program being accessible to user through a communication network and adapted to provide a user interface;
a plurality of auctions.

2. The method of claim 1 wherein a seat module that instructs the application to end the entertainment auction room and all its auctions in response to the auction reservation timing out without minimum required seat being sold.

3. The method of claim 1 wherein the said entertainment auction room upon opening transmit a plurality of bids to each participant to use at auctions of her/his choice.

4. The method of claim 1 wherein the said entertainment auction room provide a module for establishing a currency-to-points conversion ratio.

5. The method of claim 1 wherein the user interface comprise a customization module.

6. The method of claim 1 wherein the auction room offer a live auctioneer.

7. The method of claim 1 wherein a configuration for a surprise random pay is offered.

8. A method of claim 1 wherein the said entertainment auction room provide configuration for converting third party partner rewards points redemption.

9. A method for claim 1 wherein the entertainment auction room enable administering auctions from a set of items from the catalog of potential auction items; provided by third party partner's inventory management system.

10. The method of claim 1 wherein each auction in the entertainment auction room comprising:
a plurality of auction modules executed by the computer in response to a pre-set event, the modules being adapted to conduct various stages of the auction, the auction modules comprising:
a bid module that controls the auction until the auction times out;
an auction module that upon completion of the auction determines the winner of the auction;
a Buy-It-Now module executed by the computer when a bidder purchases the item being sold on the auction at a pre-determined price;
a credit module that compensate those who lost in an auction with bids that are valid for a period of time and only for certain activities.

11. The method of claim 8 wherein each auction provides for display a category of items available for auction and a starting auction price and a retail price.

12. The method of claim 8 wherein a trade in option is offered to the auction winner that allows her/him to exchange the won product with bids.

13. The method of claim 8 wherein a configuration and/or method provide an extended time auction, where the timer continues to expand until a minimum price is met.

14. An apparatus or device for producing entertainment auction room, the apparatus comprising:
a storage;
a processor;
a server operative.

15. A system for producing entertainment auction room, the system comprising a plurality of gaming or computer devices.
